(19) United States
(12) Patent Application Publication
(10) Pub. No.: US 2015/0134378 A1
(43) Pub. Date: May 14, 2015

(54) SYSTEM AND METHOD FOR SHARING ACTIONABLE TRAVEL ITINERARIES

(71) Applicant: hopOn, Inc., San Francisco, CA (US)

(72) Inventors: JADE VAN DOREN, San Francisco, CA (US); DOUG MORGAN, San Mateo, CA (US)

(21) Appl. No.: 14/538,454

(22) Filed: Nov. 11, 2014

Related U.S. Application Data
(60) Provisional application No. 61/902,601, filed on Nov. 11, 2013.

(51) Int. Cl. G06Q 10/02; G06Q 50/14; G06Q 50/00

(52) U.S. Cl. CPC G06Q 10/02; G06Q 50/01; G06Q 50/14
USPC 705/6

(57) ABSTRACT

A method for sharing actionable travel itineraries includes providing a user interface to allow the user to select from a plurality of travel services, storing a user-created actionable travel itinerary comprised of specific travel service booking information from the plurality of travel services, receiving personal information of other users, allowing users to share the actionable travel itinerary with other users, and booking the travel services for the other users by combining the information included in the actionable travel itinerary with the personal data of the other users.

### RELATED APPLICATION

This application claims priority to and the benefit of U.S. Provisional Application No. 61/902,601 filed on Nov. 11, 2013, which is incorporated herein in its entirety.

### BACKGROUND

Online travel agencies have complex methods for helping users find, compare and book flights, hotels, car rentals and other services, including searching many data sources for the lowest fares and optimizing returned search results on many variables, including nonstop flights versus flights with stops, total travel time, and hotel star ratings among others. However, online travel agencies have not helped users find, compare and book such travel services through social itinerary-sharing methods.

To the extent that such agencies provide functionality to share itineraries, the itineraries are shared in a static textual format such as an email, text message, or a text-based informational webpage. This requires users who want to re-create, modify and/or book the same or a similar itinerary to manually sift through the information contained in a static itinerary and to re-enter flight, hotel, car rental, tour and other information such as dates, times and seat assignments into an online travel agency website. Traditional static itineraries also prove inadequate for the expectations of travelers today, preventing dynamic social sharing of trip information in a number of different contexts and use cases.

Many online travel agencies save and prefill a user's travel information into a checkout process after an account login. This process helps a specific user come back to the same online travel agency to create and book a new trip without re-entering, for instance, their name and billing information. However, this method does not provide features that help other users take action based on a past or future itinerary, such as easily re-searching, re-pricing or booking such an itinerary.

Certain airline websites allow their users to save frequent searches and book new flights that start from such a saved search, which contains information such as departure city, destination city, round-trip versus one-way, and preferred departure time. While this method helps users recreate their own past flights in the future, it does not create a mechanism for making such a saved search easily sharable with a user's friends. Additionally, such saved searches are limited to airline bookings.

Certain hotel websites allow their users to save frequent searches and make new hotel bookings that start from such a saved search, which contains information such as hotel property, number of nights, and preferred room. While this method helps users recreate their own past hotel stays in the future, it does not create a mechanism for making such a saved search easily sharable with a user's friends. Additionally, such saved searches are limited to hotel bookings.

### BRIEF DESCRIPTION OF THE DRAWINGS

FIG. 1 describes a computing embodiment of the system and method.

FIG. 2 describes the components of an actionable travel itinerary

FIG. 3 describes an actionable itinerary use case, where a user books the same trip as an organizer.

FIG. 4 describes an actionable itinerary user case, where a user joins the organizer's trip, but modifies it before booking.

FIG. 5 describes an example use case of an actionable itinerary, where a user starts from a friend's past trip to book a future trip.

FIG. 6 describes methods of sharing actionable itineraries.

FIG. 7 describes invitation methods for passively-shared actionable itineraries.

FIG. 8 describes searching actionable itineraries.

FIG. 9 describes examples of additional types of bookings that can be included in actionable itineraries.

FIG. 10 describes the dynamic booking process for sharing costs across actionable itineraries.

FIG. 11 describes alternative implementations of the dynamic booking process.

FIG. 12 describes alternative payment methods involved with the dynamic booking process.

FIG. 13 describes auto-booking mechanisms based on social factors involved with the dynamic booking process.

FIG. 14 describes the sharing of saved user information for the purpose of allowing an organizer to book for the user.

FIG. 15 describes the sharing of saved user information in concert with dynamic booking process.

FIG. 16 describes a user who views the actionable itineraries of other users on the same trip, and who switches to another actionable itinerary within the same trip.

FIG. 17 describes how an organizer can charge users for services rendered by the organizer, or other fees.

FIG. 18 describes how each user may be the organizer of a specific element of the actionable itinerary and a user of other elements.

FIG. 19 shows an example of a status of bookings for an actionable itinerary.

FIG. 20 shows an example of a newsfeed display of an actionable itinerary.

### DETAILED DESCRIPTION OF THE EMBODIMENTS

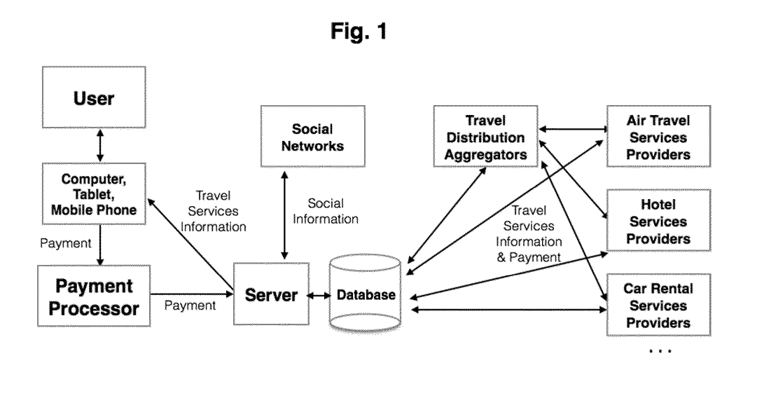

One approach is to provide a system for users to create and share actionable travel itineraries. As shown in FIG. 1, this involves sourcing travel services content from aggregators, and/or directly from providers, referred to in this discussion collectively as travel service providers, passing such information through a server and database, and on to users. Users are provided with an interface on a computer, tablet or mobile phone to purchase travel services, and pass payment back to the system, for instance through a payment processor. The particular combination of travel services booked by the user will be referred to here as an actionable travel itinerary. By gathering user data from social networks, such as friend lists and demographic information, the system can provide and recommend specific travel services for users in new ways described below.

The travel services may include all or a portion of the actionable travel itinerary. The travel services may include airline tickets, hotel reservations, car rentals, activity bookings, restaurant reservations, concert tickets, ski lift tickets, vacation rentals, car sharing services, catering services, and custom bookings, wherein custom bookings contain links to other websites where users can book services not available for booking directly in the system.

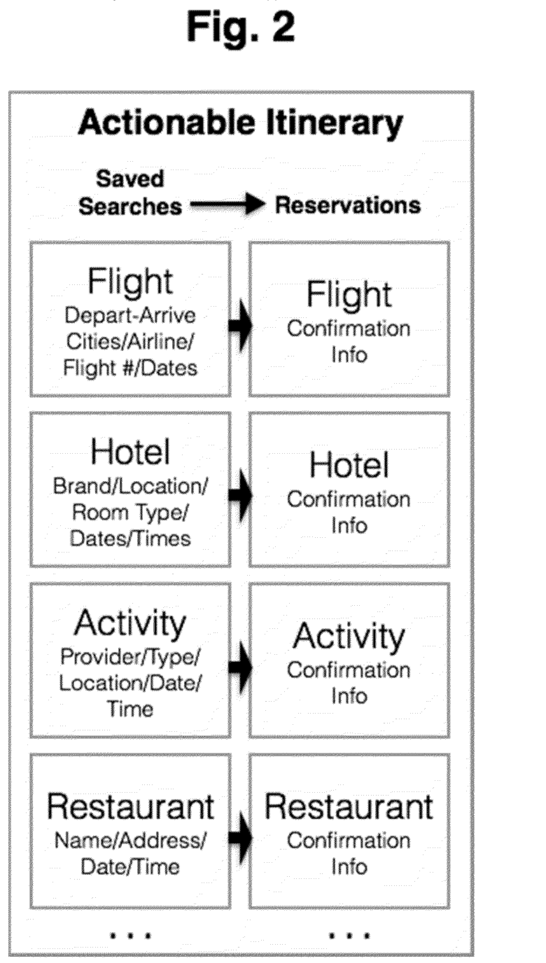

Users that want to join their friends on a trip would like to be able to see their friends' itineraries in an actionable format that would allow the user to book their friend's trip directly, maybe even in a ‘one-click’ manner, and/or to easily use such itineraries as a template for booking their own, slightly different trip. FIG. 2 describes the components of such an actionable travel itinerary, which is comprised of a plurality of saved travel information for a specific travel service obtained by searching the databases of travel services providers, as well as a plurality of related bookings. In this discussion, the user that sets up the first actionable travel itinerary may be referred to as the original user.

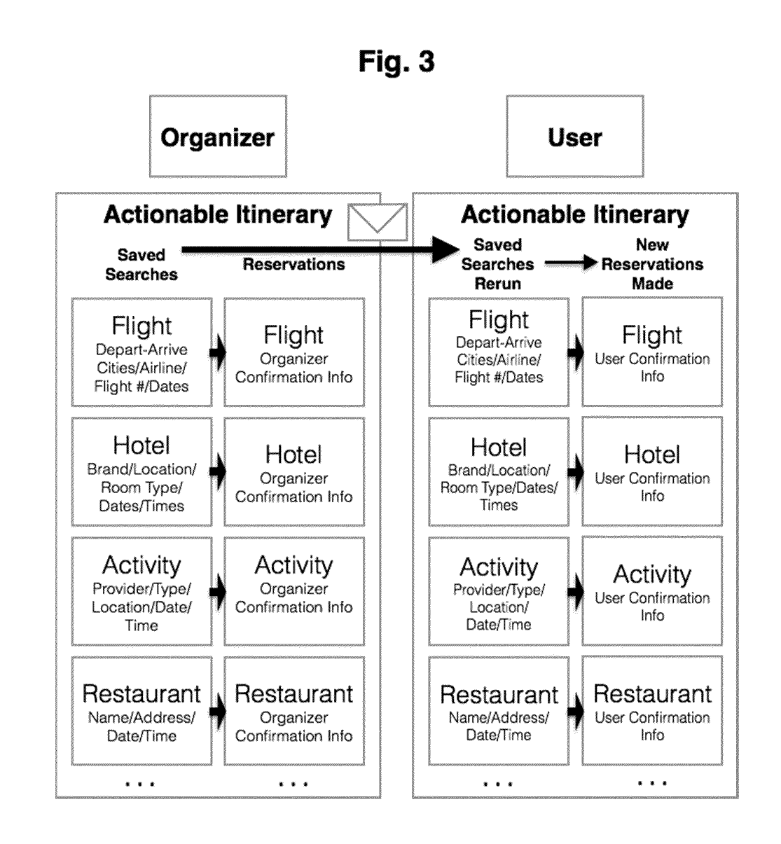

FIG. 3 describes an example use case where a user wants to book exactly the same trip as a trip organizer, for instance if the user will be traveling together with the organizer for the whole trip. In this example, the organizer invites a user to join a trip by email link, the travel services information is rerun for each of the plurality of items, each is re-priced, and the user books the same actionable itinerary as the organizer, using a combination of the travel information contained in the actionable itinerary and the personal information included in the user's profile. The personal information or data may include the name of the user, address, date of birth, credit card information, frequent flyer numbers, hotel loyalty numbers, passport number, known traveler number, redress number and billing information.

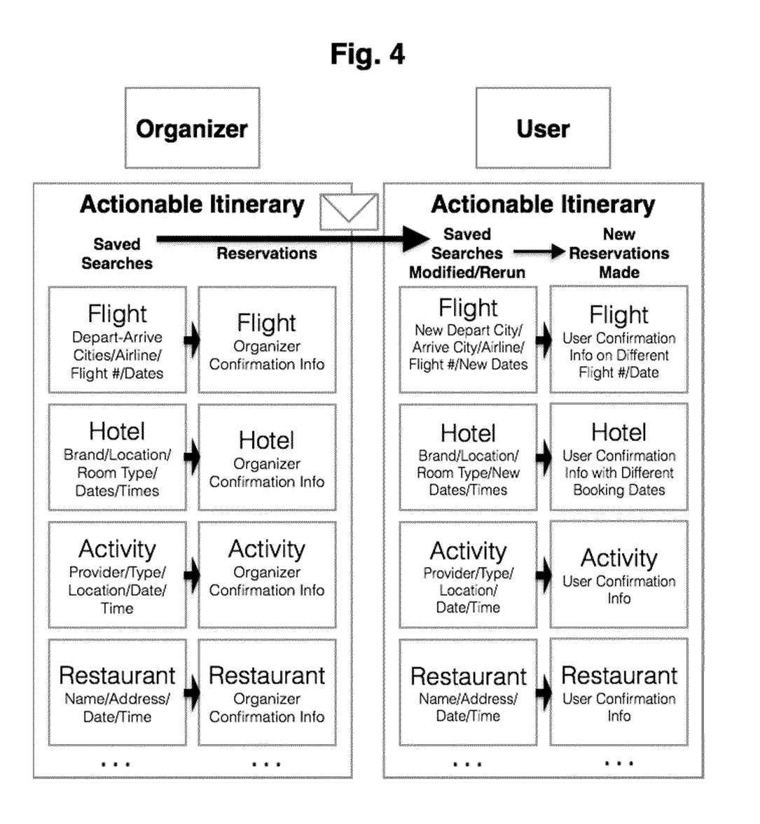

As shown in FIG. 4, users also want to start from an organizer's itinerary and modify it before booking, for example if the user will be traveling with the group for only part of the trip—as in the case that the user will be traveling for slightly different dates, or is flying from a different city.

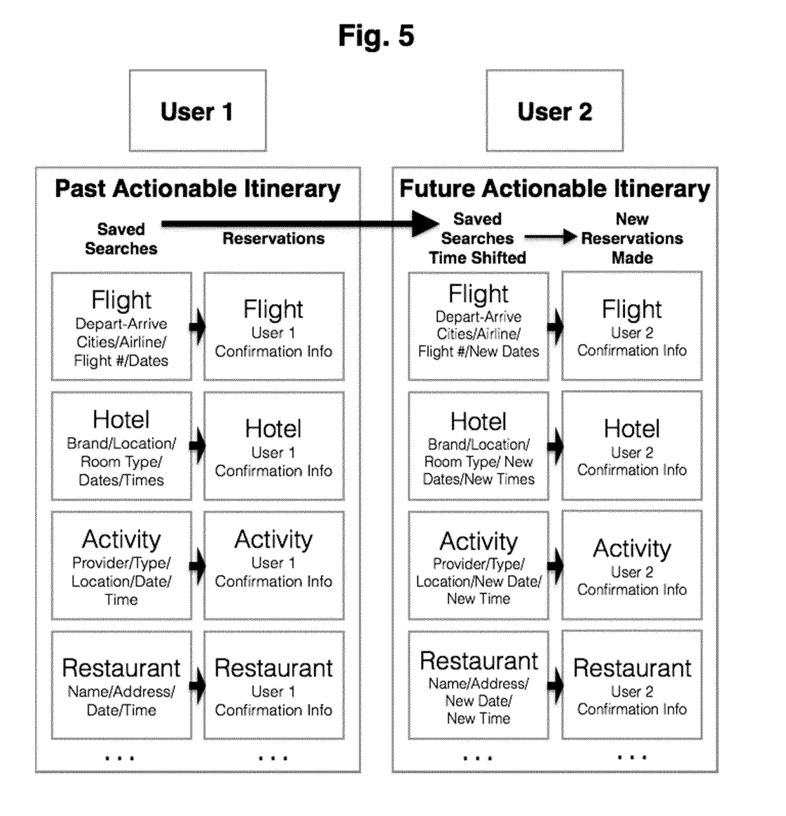

As shown in FIG. 5, users who want to recreate a friend's past trip in the future also want to be able to see their friend's past itineraries in an actionable format so that they can easily re-price, modify, and/or book one of those itineraries at another time, rather than reentering the data for a number of different flights, hotels, activities and other services, searching one-by-one, and rebuilding the itinerary from scratch.

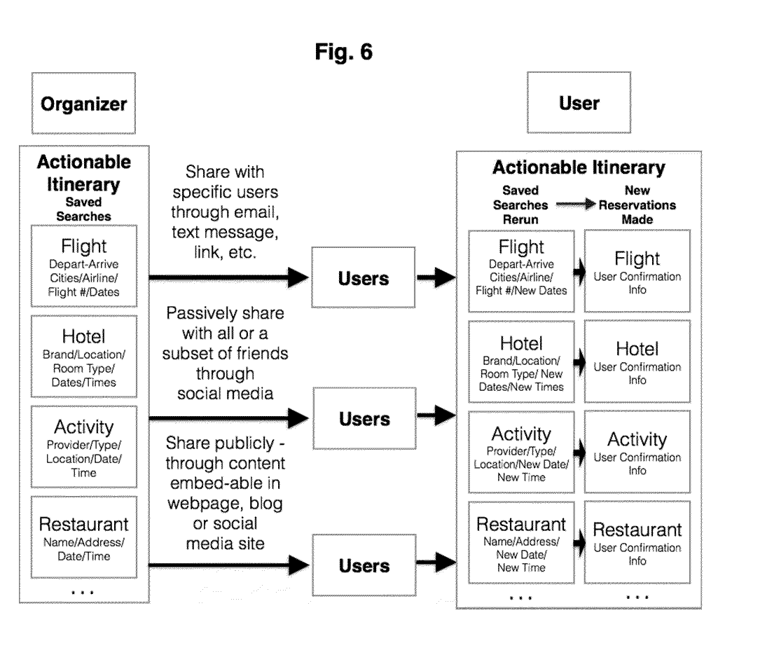

As shown in FIG. 6, depending on the type of trip being planned, organizers of trips may want to share actionable itineraries only with people they actively invite, with all or a subset of their friends or contacts from a specific social network, or publically with everyone.

In the case that organizers want to share such actionable itineraries with specific users, they may want to share through email, or by a link or embeddable content to such an actionable travel itinerary in a format that allows the receiving user to easily see details about the specific travel services the comprise the actionable travel itinerary, modify and book the itinerary or specific travel services contained within the itinerary.

In the case that organizers want to share such actionable itineraries with friends or connections from a specific social network, they want to make the information available passively to their friends, or a subset of friends on a social network so that those friends can find the organizer's trips when searching or browsing. A friend or connection that is searching may desire to find and act on itineraries their friends' have taken or are planning to take to a specific area, such as a country, state, or city, an event such as a wedding, sporting event, or festival, or location such as a hotel, activity provider, or restaurant.

In the case that organizers want to share such actionable itineraries publically, for instance to simplify searching, pricing and booking for people travelling to a sporting event or concert, perhaps from a specific city, organizers want to embed such an actionable itinerary in a webpage, blog, or social networking site so that visitors can easily search, price and book such a public trip.

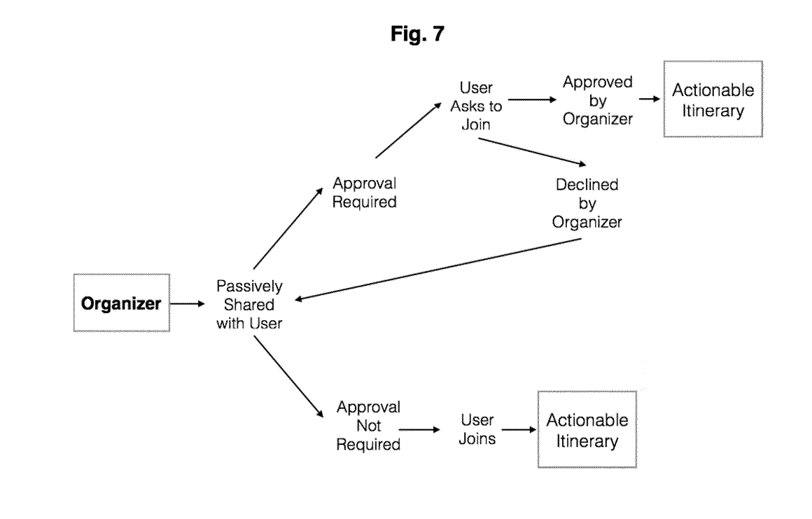

As shown in FIG. 7, the organizer of a future actionable itinerary that is passively shared through social networks or publically can allow users with whom such an actionable itinerary is shared to join without additional approval, or the organizer can require such users to ask to join their actionable itinerary, and the organizer can then approve such requests individually, perhaps after reviewing information about the user from social networks.

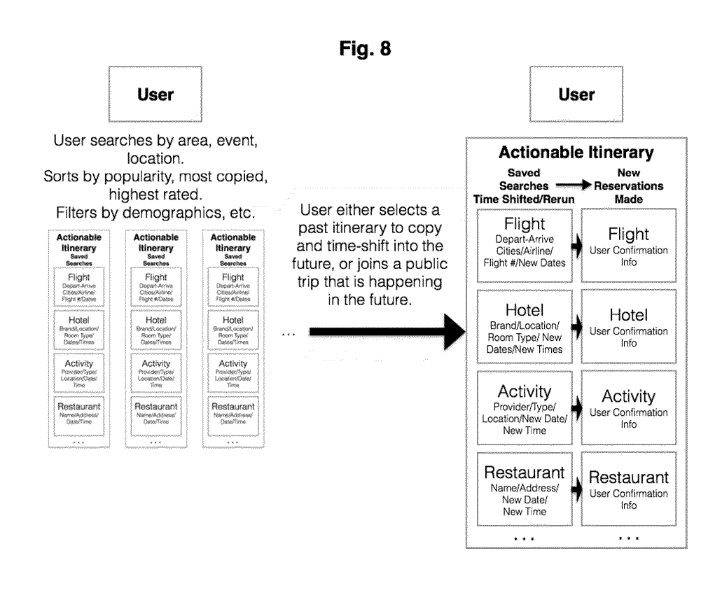

As shown in FIG. 8, users want to search such shared, meaning shared publically, through social networks, or directly, actionable itineraries to find the most-popular, most-copied, or highest-rated itineraries for a specific areas, event, or location. Users also want to search or filter by demographics to find the most popular actionable itinerary to a specific area, event or location for people in their demographic group, or a demographic group of people the user may want to meet. The actionable itineraries being searched can be from the past and time-shifted into the future as above, or they can be future trips that a user can join, or ask to join as above.

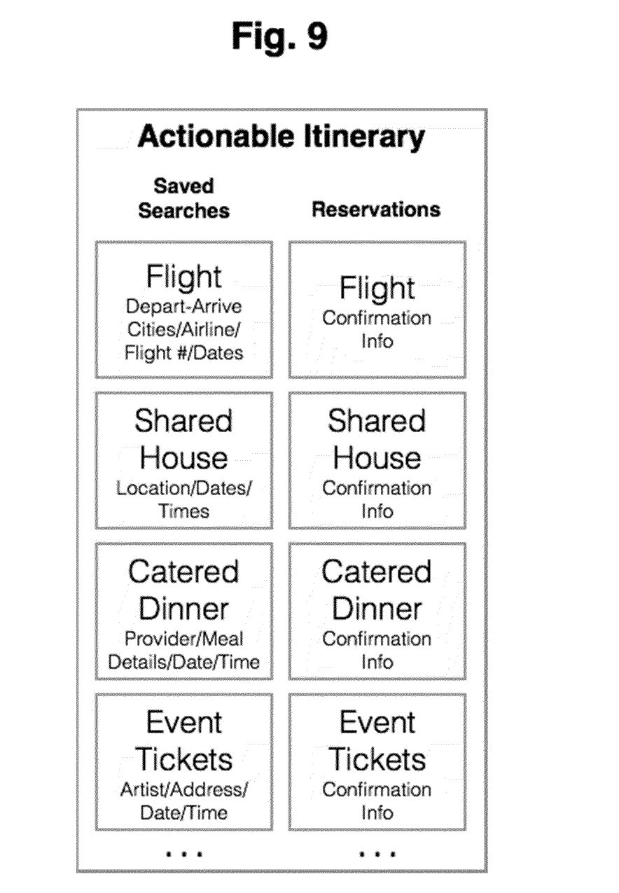

As shown in FIG. 9, regardless of with whom such actionable itineraries are shared, they may contain more types of bookings than the standard online travel agency offerings, which mostly offer flights, hotels, car rental and activities. Such lists can additionally contain restaurant reservations, concert tickets and ski lift tickets, as well as so-called collaborative consumption services such as vacation rentals, car sharing services, and catering services. Such actionable itineraries can also contain custom bookings that contain links to other websites where users can book services that may not be available for booking directly in the system. For example, an organizer could add a new element to an actionable itinerary to communicate to users that they need to purchase a concert ticket that is only available by following instructions outside of the system, e.g. on a different website, by calling a phone number, etc.

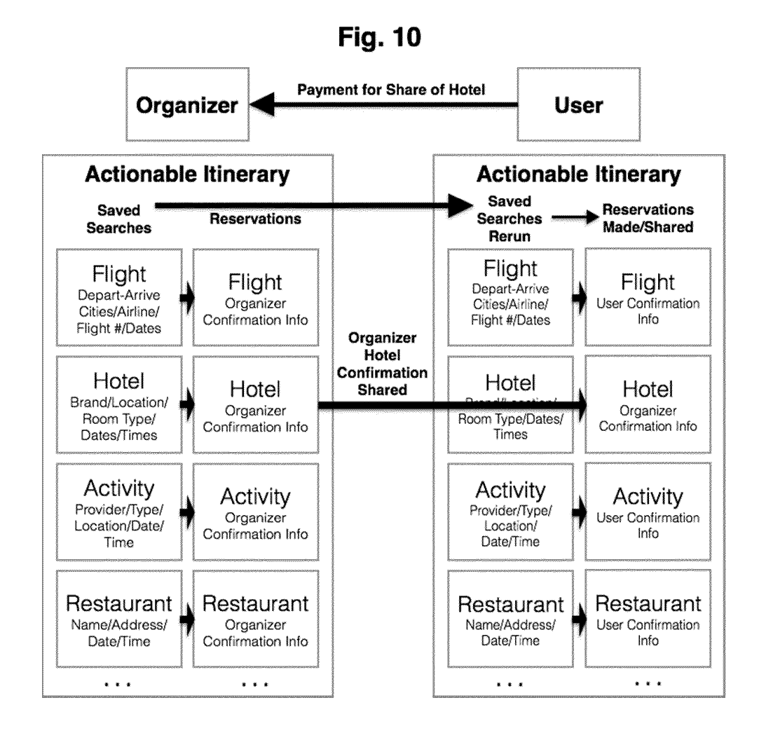

As shown in FIG. 10, many services booked as part of an actionable travel itinerary can be shared between organizers and users. For example, an organizer can book a hotel room, and then split the cost with a user. The user books the other components of the actionable itinerary directly.

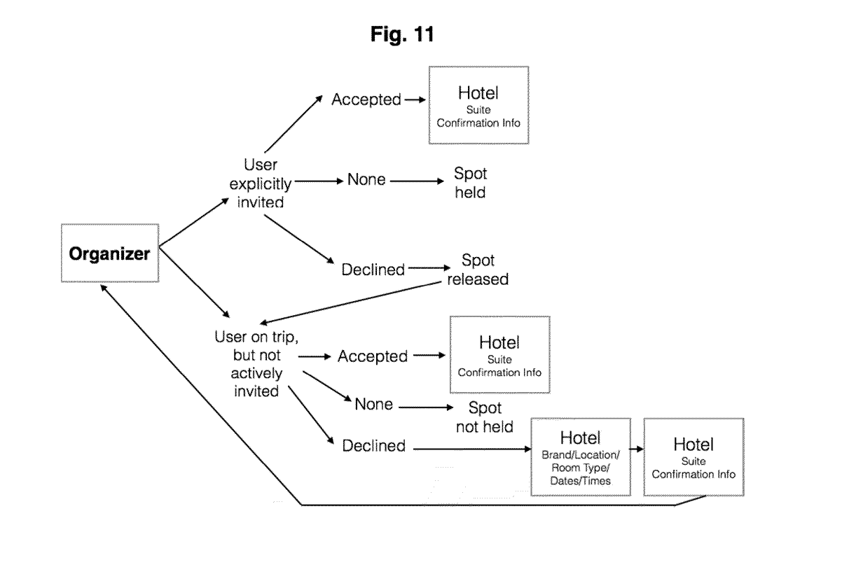

As shown in FIG. 11, in the use case above, the organizer may propose that the payment be split between several specific users, or can make the spaces in the hotel suite available to any user who has been invited to the trip on a first-come, first-served basis, or can reserve spots for certain users and open the rest of the spots on a first-come, first served basis. Invited users can then agree or decline to share the room and thus agree or decline to reimburse the organizer. Users who have declined can then decide to book their own room and potentially share that room with others on the trip.

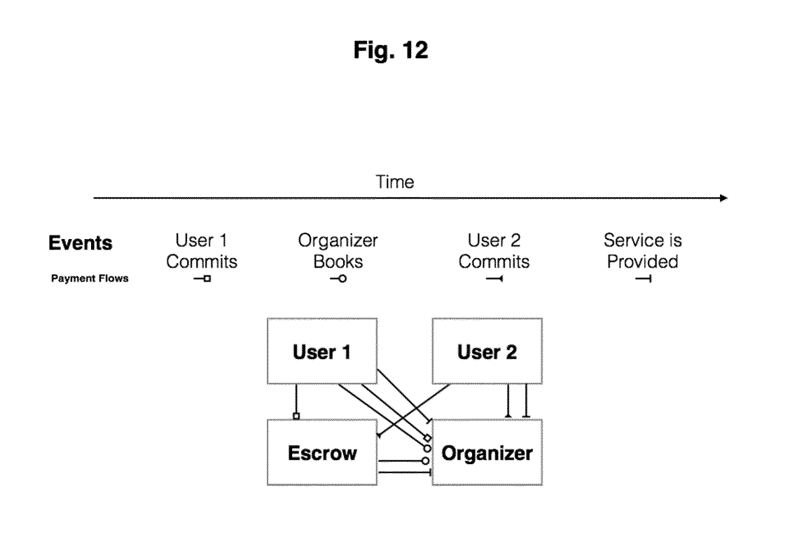

As shown in FIG. 12, in the example above, the user may be charged when the user makes a commitment to share the component of the trip, when the organizer books such a component, or after the service has actually been provided. Regardless of when the user is charged, the user's payment may be paid out immediately to the organizer, or held in escrow and only paid out at a later step.

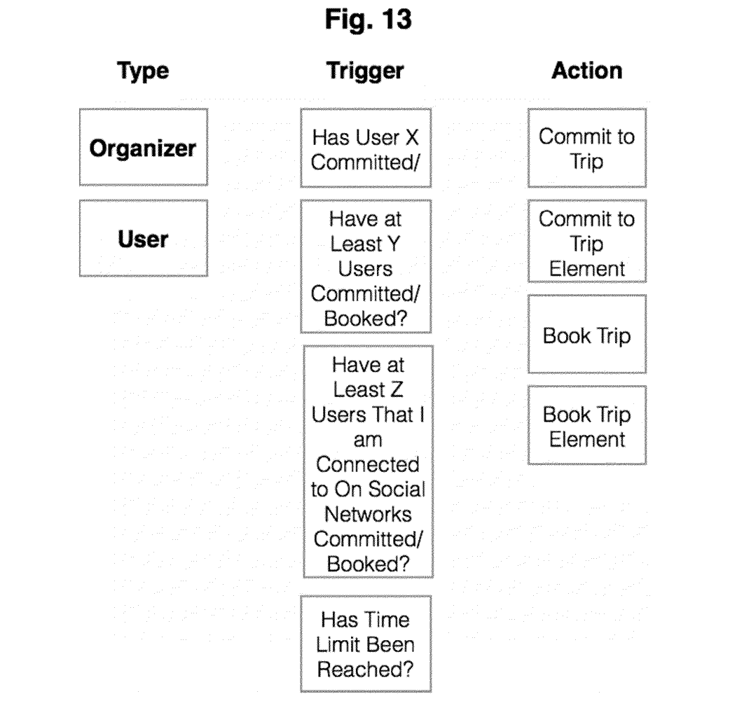

As shown in FIG. 13, organizers and users may set up auto-booking features that trigger a commitment to, or booking of, a shared trip element. Examples include a user setting up an auto-booking trigger that books a flight if a specific user books that flight, or an auto-commitment trigger to a shared trip element as soon as X other users, or optionally X other users that that the user is connected to on a social network, have booked. Alternately, for example, organizers may set up a hotel booking trigger as soon as Y users commit. Organizers and users can also set a time limit by which commitment or booking will occur. Multiple triggers can be required for an action to occur, for instance, user A must have booked, and Z users must have committed, and the time limit must have been reach for the user to be committed to a trip element.

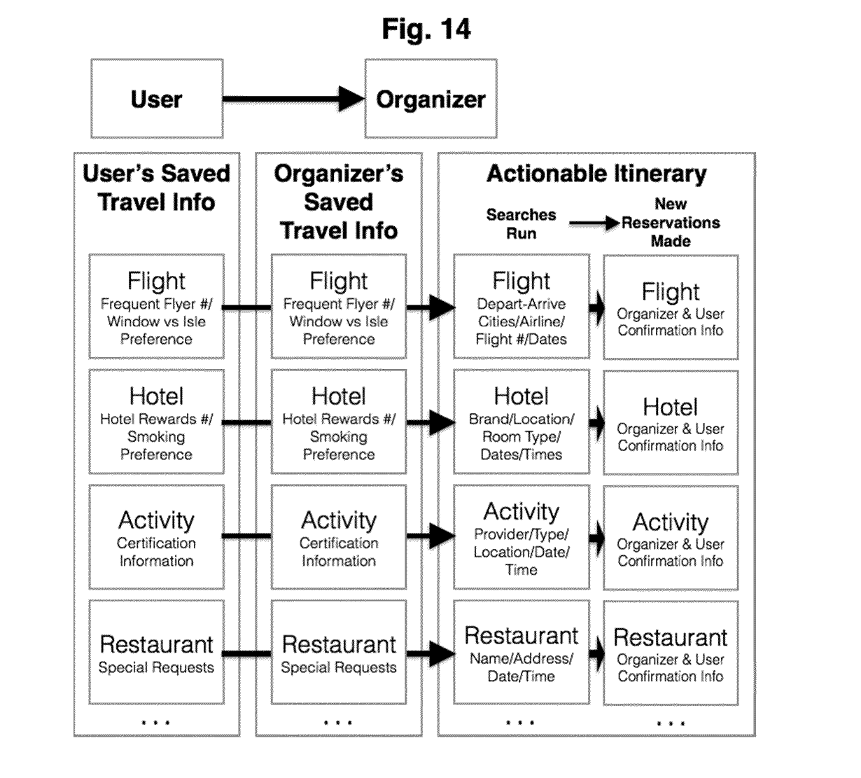

As shown in FIG. 14, related functionality may be provided by sharing a user's travel profile information, such as name, birthday, gender, frequent flyer numbers, TSA known traveler number, actively with specific people, passively with friends from a social network, or publically once booked, so that organizers can purchase flights, hotels, etc. for a user using the organizer's payment information, but the users travel data, with the expectation that the organizer will be paid back at a later time, perhaps through a process like the dynamic reimbursement as described above.

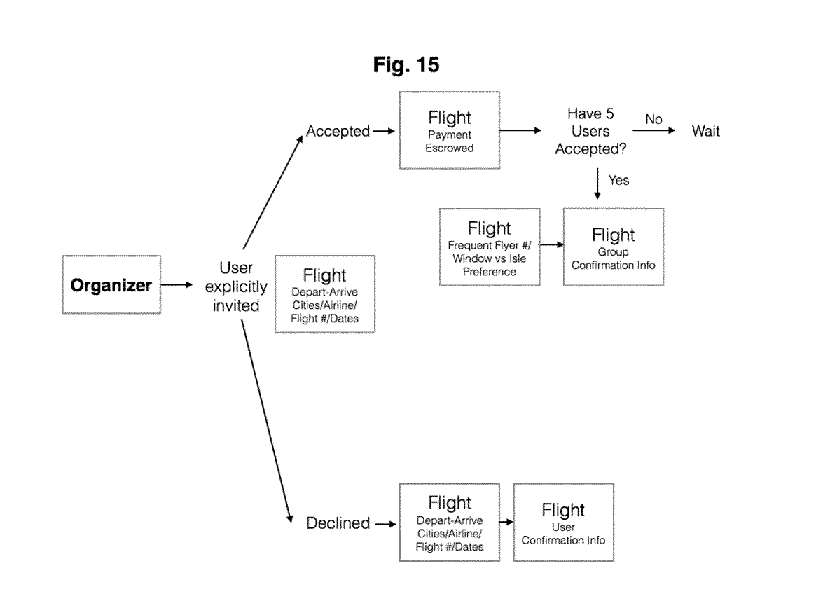

As shown in FIG. 15, when combined, the methods discussed above can be powerful. As an example, an organizer can invite several users to dynamically reimburse him if he books the flights for everyone. The users can accept the invitation, or decline and book their own flights. The organizer can set up the process to automatically book the flights, using shared travel profile information, and other trip elements when X users have approved payment to him for the flights. Because the organizer has booked all of the flights on the same reservation, the organizer can, for instance, reschedule all of the flights for the group if needed. Additionally, the organizer has not taken a risk on the money required to purchase the tickets.

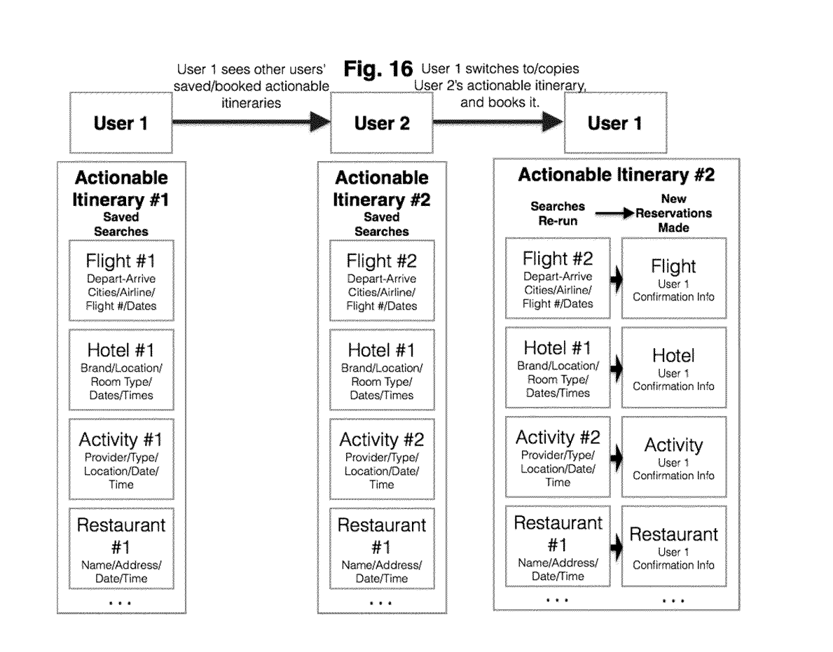

As shown in FIG. 16, users who have joined the organizer's actionable itinerary may be able to view the actionable itineraries of other users who have joined the organizer's actionable itinerary. A user that has joined an actionable itinerary created by an organizer could see which other actionable itineraries within the group are unique and can switch to a different actionable itinerary easily. For instance, if the organizer is departing from one city (SFO), and a user has modified their actionable itinerary to depart from a second city (LAX), another user who is coming from the same city as the first user (LAX) can switch actionable itineraries easily.

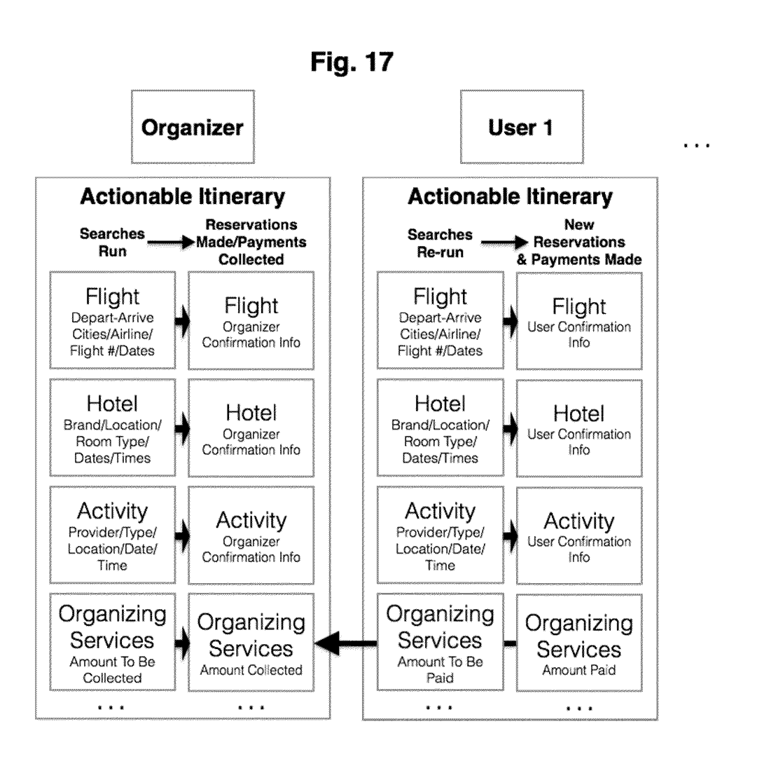

As shown in FIG. 17, organizers can charge a fee to users at a group level, or an individual level through the dynamic reimbursement method described above, for services provided, offline costs, penalties, fees, and other charges.

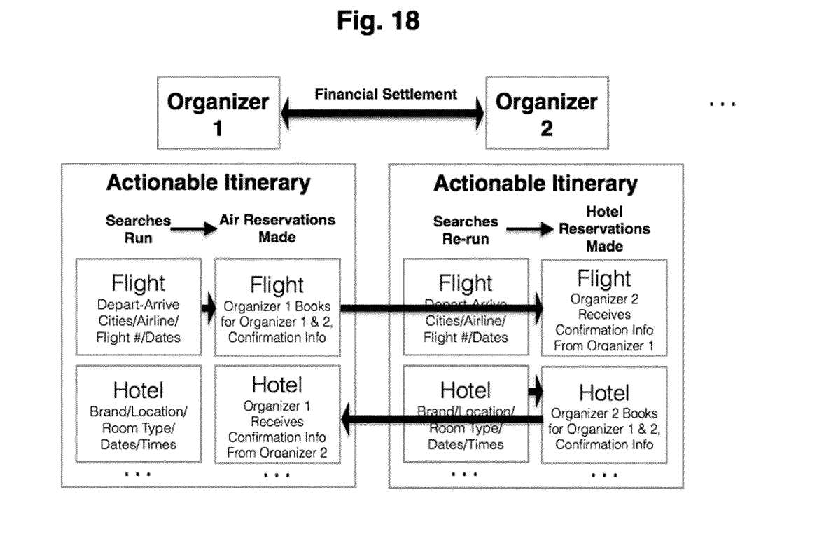

As shown in FIG. 18, each user may be an organizer of a specific element of an actionable itinerary, and a user of other elements of the itinerary, for instance in the case that a user joins a trip where the organizer has booked all of the flights, but the user books a suite and shares it with several friends who are also going on the trip, and so is an organizer of that trip element. Settlement of costs may occur between the two organizers.

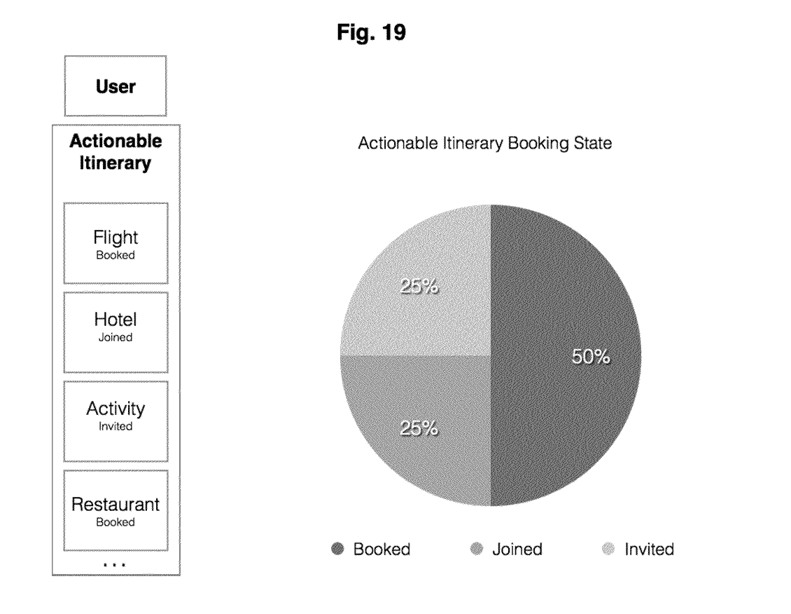

As shown in FIG. 19, each element of an actionable itinerary can have a booking state, for instance: invited, joined, or booked. Each booking state can be communicated to the user through a specific color, icon or other indication. An actionable itinerary can also have an overall indication of the number of elements that fall into each booking state at any given time, and such an indication can be shared with the organizer and other users to easily communicate the booking status of such users. Such an overall booking status indicator for an actionable itinerary can be weighted by the number of elements in each state, the percentage of the total trip cost that falls into each booking state, or by other methods.

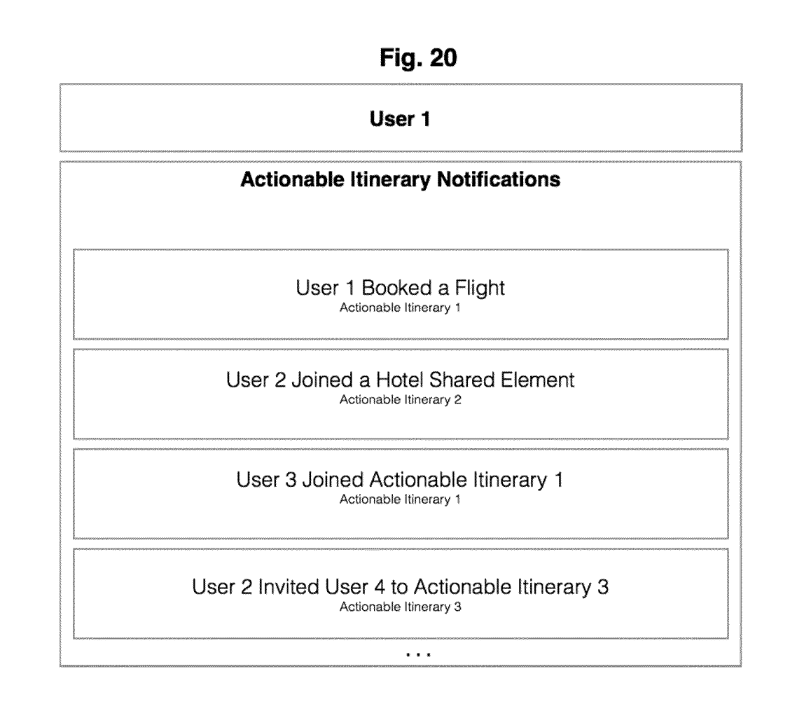

As shown in FIG. 20, the changes in state for each element of an actionable itinerary can be aggregated into a newsfeed type display, so that an organizer or user can easily see the notifications associated with the actionable itineraries they have been invited to, joined, and/or booked. Such notifications can include changes in booking state to actionable itineraries or elements of actionable itineraries that a user is associated with, as well as other types of information about the itinerary, such as flight cancellations, weather warnings, travel advisories, etc.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the embodiments here.

What is claimed is:

1. A method for sharing actionable travel itineraries, comprising:
providing a user interface to allow the user to select from a plurality of travel services;
storing a user-created actionable travel itinerary comprised of specific travel service booking information from the plurality of travel services;
receiving personal information of other users;
allowing users to share the actionable travel itinerary with other users; and
booking the travel services for the other users by combining the information included in the actionable travel itinerary with the personal data of the other users.

2. The method of claim 1 wherein travel services further comprises at least one of airline tickets, hotel reservations, car rentals, activity bookings, restaurant reservations, concert tickets, ski lift tickets, vacation rentals, car sharing services, catering services, and custom bookings, wherein custom bookings contain links to other websites where users can book services not available for booking directly in the system.

3. The method of claim 1 wherein personal data further comprises at least one of the name of the user, address, date of birth, credit card information, frequent flyer numbers, hotel loyalty numbers, passport number, known traveler number, redress number and billing information.

4. The method of claim 1, wherein sharing the actionable travel itinerary comprises sharing the actionable travel itinerary with at least one of email contacts of the user, friends of the user, followers of the user on social networks as one of either information to such social networks for display or passively through a search or browsing, through an application configured to be embedded in a web page, as a template having shiftable dates and dynamic pricing.

5. The method of claim 1 wherein the actionable travel itinerary comprises a changeable travel itinerary accommodating at least one of adding travel services or removing travel services.

6. The method of claim 1 further comprising enabling a user to book at least a portion of actionable travel itineraries, using the information included in the actionable travel itinerary of the other user combined with personal information of the other user and billing information for one of the user or the other user.

7. A computer-implemented method and system for sharing actionable travel itineraries, comprised of:
sourcing travel services from travel service aggregators or directly through providers of travel services;
storing information corresponding to the travel services in at least one database;
providing an interface for users to select and save travel services as an actionable travel itinerary;
facilitating the purchase of the actionable travel itinerary or travel services directly by combining the information included in the actionable travel itinerary with personal data associated with an original user;
sharing such an actionable travel itinerary with other users;
providing an interface to the other users, the interface allowing the other users to book the travel services by combining the information corresponding to the actionable travel itinerary with personal data of the other users.

8. The method of claim 7 wherein travel services further comprises at least one of airline tickets, hotel reservations, car rentals, activity bookings, restaurant reservations, concert tickets, ski lift tickets, vacation rentals, car sharing services, catering services, and custom bookings, wherein custom bookings contain links to other websites where users can book services not available for booking directly in the system.

9. The method of claim 7, wherein personal data further comprises at least one of the name of the user, address, date of birth, credit card information, frequent flyer numbers, hotel loyalty numbers, passport number, known traveler number, redress number and billing information.

10. The method of claim 7, wherein sharing the actionable travel itinerary comprises sharing the actionable travel itinerary with at least one of email contacts of the user, friends of the user, followers of the user on social networks as one of either information to such social networks for display or passively through a search or browsing, through an application configured to be embedded in a web page, as a template having shiftable dates and dynamic pricing.

11. The method of claim 7, further comprising enabling a user to book at least a portion of actionable travel itineraries, using the information included in the actionable travel itinerary of the other user combined with personal information of the other user and billing information for one of the user or the other user.

12. An article of non-transitory, a machine-accessible storage medium including instructions that, when accessed by a machine, cause the machine to:
source travel services from travel service aggregators or directly through providers of travel services;
store information corresponding to the travel services in at least one database;
provide an interface for users to select and save travel services as an actionable travel itinerary;
facilitate the purchase of the actionable travel itinerary or travel services directly by combining the information included in the actionable travel itinerary with personal data associated with an original user;
share such an actionable travel itinerary with other users;
provide an interface to the other users, the interface allowing the other users to book the travel services by combining the information corresponding to the actionable travel itinerary with personal data of the other users.

13. An system, comprising:
at least one server to access information related to travel services from travel service providers, the server having a network connection to allow access to the travel service providers;
at least one database to store the information related to travel services and user personal data;
a first user interface to allow original users to select, save and purchase travel services as an actionable travel itinerary by combining selected information related to travel services and the user personal data; and
a second user interface to allow original user to share the actionable travel itinerary with other users in a manner allowing the other users to book the travel services directly by combining the information related to the travel services in the actionable travel itinerary with personal data of the other users.
